(19) United States
(12) Patent Application Publication
(10) Pub. No.: US 2009/0009592 A1
(43) Pub. Date: Jan. 8, 2009

(54) Three-Dimensional Image Forming System

(75) Inventors: Yoshiki Takata, Mie (JP); Takashi Morimoto, Nara (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 11/576,407

(22) PCT Filed: Sep. 30, 2005
(86) PCT No.: PCT/JP2005/018197

§ 371 Date: Aug. 15, 2007

(30) Foreign Application Priority Data
Oct. 1, 2004 (JP) 2004-290820

(51) Int. Cl. H04N 13/02

(52) U.S. Cl. 348/47

(57) ABSTRACT

Information for each of a right eye and a left eye obtained by a pair of cameras, which is provided on a three-dimensional image information obtaining apparatus, is displayed on a three-dimensional image display apparatus. An optical axis of each of the cameras is disposed so as to intersect each other on a horizontal surface or on a surface inclined with respect to the horizontal surface. Based on a detection result of a distance sensor for detecting a distance between each of the cameras and a subject, an image capturing position of each of the cameras is adjusted such that the intersection point of the optical axes of the cameras is on the subject. The image information for the right eye and the left eye obtained by the three-dimensional image information obtaining apparatus is printed on a recording sheet by a three-dimensional image printer. Hence, it is possible to positively obtain a three-dimensional image in line with a stereoscopic image recognized by a user's eyes.

### BACKGROUND OF THE INVENTION

1. Field of the Invention

The present invention relates to a three-dimensional image forming system capable of forming a three-dimensional image in line with a stereoscopic image recognized by a person's eyes.

2. Description of the Related Art

In order to record the information recognized by a person's eyes as an image, a “camera” is normally used. The “camera” displays, on a recording paper, image information corresponding to a stereoscopic image recognized by the user's eyes in a two-dimensional manner. In addition, an “instant camera” which immediately displays image information on the recording paper in the two-dimensional manner is disclosed, for example, in Japanese Laid-Open Publication No. 03-34684 (Reference 1).

However, image information is displayed on the recording paper in the two dimensional manner in the case of the normal “camera”. Thus, the obtained two-dimensional display image is represented differently from the three-dimensional stereoscopic image that is actually recognized by the user's eyes. Therefore, there is a concern that the information of an actual stereoscopic image is not accurately conveyed.

Recently, along with the advancement of the image processing technique, a technique of displaying a three-dimensional image (3-D image) on a display panel and a technique of printing the three-dimensional image on a recording paper are being developed. In a three-dimensional display apparatus, image information for each of the right eye and the left eye, which corresponds to the respective information recognized by each of the right eye and the left eye of an observer, is normally obtained in advance by a camera. The obtained image information for each of the right eye and the left eye is displayed on a display panel (e.g., liquid crystal panel) having a parallax barrier provided thereon such that it can be viewed by each of the right eye and the left eye of the observer. In the display panel, the obtained image information for each of the right eye and the left eye is divided into longitudinal strip shapes having a constant width, which correspond to respective pixel columns so as to be displayed in an alternating manner on each pixel column along a column (longitudinal) direction of the display panel, and the obtained strip-shaped image information for each of the right eye and the left eye is displayed in an alternating manner on each pixel column of the display panel. Also, a parallax barrier is disposed at a location in front of the display panel such that the image information for each of the right eye and the left eye displayed on each pixel column of the display panel can be viewed by each of the right eye and the left eye of the observer.

In addition, Japanese Laid-Open Publication No. 64-41397 (Reference 2) discloses a three-dimensional image capturing apparatus for capturing a three-dimensional image.

Further, a three-dimensional image printer is being developed, which prints image information for each of the right eye and the left eye on a recording paper. For example, Japanese Laid-Open Publication No. 2000-180996 (Reference 3) discloses a structure of printing image information for each of the right eye and the left eye on a special lenticular sheet. In addition, Reference 4 discloses a structure of printing a parallax barrier and image information on a transparent sheet.

According to an image capturing apparatus described in Reference 2, three-dimensional image information can be obtained by this apparatus. However, it is not possible to confirm a three-dimensional image, which is formed based on the obtained three-dimensional image information, at the site where the image was captured. As such, the problem with this apparatus is that it requires a separate display apparatus, printer or the like to confirm the three-dimensional image obtained.

According to a printer described in Reference 3, it is necessary to use a special lenticular lens. The fine lenticular lens is extremely easy to sustain damage, and further an optical effect thereof is significantly affected by the damage. Accordingly, manufacturing a printer capable of obtaining a three-dimensional image with a predetermined level requires a low mass productivity and a strict management level. Further, forming a lenticular lens which is a fine optical device in a sheet requires a high precision die, which is difficult to manage, and a manufacturing line, which has a high degree of cleanness. This results in a problem of impairing the economic efficiency. Further, Reference 4 requires printing not only the image information but also a parallax barrier, thus requiring an apparatus having a complex structure, which also results in impairing the economic efficiency.

Further, both Reference 3 and Reference 4 obtain image information for each of the right eye and the left eye by a camera or the like and print the obtained image information by a printer, which is separate from the camera, thus causing a time difference between the time at which the image information is obtained by the camera and the time at which the obtained image information is actually printed. Accordingly, there is a concern that the three-dimensional image on a three-dimensional image print obtained by the printer may be significantly different from the stereoscopic image actually recognized by eyes. As a result, there is a concern that a user may not be able to assuredly obtain a desired three-dimensional image.

### SUMMARY OF THE INVENTION

The present invention is intended to solve such problems described above. The objective of the present invention is to provide a three-dimensional image forming system, which is capable of positively obtaining a three-dimensional image in line with a stereoscopic image recognized by the user's eyes; and which also has a high economic efficiency.

A three-dimensional image forming system according to the present invention includes: a three-dimensional image information obtaining apparatus for obtaining image information for each of a right eye and a left eye; an image information control section for image-processing the image information for each of the right eye and the left eye obtained by the three-dimensional image information obtaining apparatus; and a three-dimensional image display apparatus including a display section for displaying the image information for each of the right eye and the left eye obtained by the image information control section such that each image information is observed by the right eye and the left eye of an observer, respectively.

Preferably, the three-dimensional image information obtaining apparatus includes means for changing a parallax angle, the parallax angle occurring when the image information for each of the right eye and the left eye is obtained.

Preferably, the three-dimensional image information obtaining apparatus includes a pair of cameras disposed with a predetermined interval there between in order to obtain the image information for each of the right eye and the left eye, and an optical axis of each of optical systems of the respective cameras is disposed so as to intersect each other on a horizontal surface or on an inclined face inclined with respect to the horizontal surface.

Preferably, the three-dimensional image information obtaining apparatus includes a distance sensor for detecting a distance between each of the cameras and a subject, and an optical axis direction of each of the cameras is adjusted based on a detection result of the distance sensor such that an intersecting point of the optical axes of the cameras is on the subject.

Preferably, a focal position of each camera of the three-dimensional image information obtaining apparatus is automatically adjusted based on the distance sensor.

Preferably, the image information control section image-processes and outputs the image information for each of the right eye and the left eye obtained by the image information obtaining apparatus such that each image information is displayed by the display section of the three-dimensional image display apparatus in an alternating manner in a left-and-right direction.

Preferably, the display section of the three-dimensional image display apparatus includes a display panel; and a parallax barrier disposed along the display panel such that the image information for each of the right eye and the left eye displayed on the display panel is observed by the right eye and the left eye of the observer, respectively.

Preferably, the three-dimensional image forming system further includes a three-dimensional image printer for forming a three-dimensional image print based on an output from the image information control section.

Preferably, the three-dimensional image information obtaining apparatus, the three-dimensional image display apparatus, the image information control section and the three-dimensional image printer are held in a portable casing.

Preferably, the three-dimensional image information obtaining apparatus, the three-dimensional image display apparatus, the image information control section and the three-dimensional image printer are held in a fixed-type casing, and each camera of the image information obtaining apparatus is disposed such that the observer of the three-dimensional image display apparatus becomes the subject.

Preferably, the three-dimensional image display apparatus includes a touch panel on a display surface thereof, and the three-dimensional image information apparatus can be operated by an operation of the touch panel.

Preferably, the touch panel employs a pen input method.

Preferably, the three-dimensional image forming system further includes storage means for storing the image information for each of the right eye and the left eye obtained by the image information control section.

Preferably, the storage means is detachable from the casing.

Preferably, the three-dimensional image printer includes a printer head for printing the image information output from the image information control section for each of the right eye and the left eye on a recording sheet in an alternating manner in a left-and-right direction.

Preferably, the three-dimensional image printer further includes means for attaching a parallax barrier film on the recording sheet having the image information of each of the right eye and the left eye printed thereon by the printer head in the alternating manner, light transmissive areas respectively corresponding to each printed image information being provided in the parallax barrier film, such that each light transmissive area corresponds to each image information printed on the recording sheet, respectively.

Preferably, the recording sheet of the three-dimensional image printer includes a translucent sheet; and a parallax barrier sheet on one side of the translucent sheet, a plurality of light transmissive areas being provided in the parallax barrier sheet side by side in the left-and-right direction, and the printer head prints the image information for each of the right eye and the left eye on a side, on which the parallax barrier film of the translucent sheet in the recording sheet is not provided, in the alternating manner in the left-and-right direction so as to correspond to each of the light transmissive areas.

Preferably, the parallax barrier film of the three-dimensional image printer includes a plurality of translucent portions facing each of print positions of the image information for each of the right eye and the left eye in the recording sheet; and a plurality of light shielding portions for shielding light irradiating between each of the translucent portions.

Preferably, the recording sheet includes an adhesive layer on a back side thereof.

Preferably, a release paper is provided on a surface of the adhesive layer.

Preferably, the three-dimensional image display apparatus is a liquid crystal display apparatus.

The three-dimensional image forming system according to the present invention has a simple structure with an excellent economic efficiency and can easily and economically form a three-dimensional image in line with a stereoscopic image recognized by a person's eyes.

### BRIEF DESCRIPTION OF THE DRAWINGS

FIG. 1 is a block diagram schematically showing a structure of a three-dimensional image forming system according to the present invention.

FIG. 2 is a schematic structural diagram of a three-dimensional image display apparatus used in the three-dimensional image forming system.

FIG. 3 is schematic structural diagram of a three-dimensional image printer used in the three-dimensional image forming system.

FIG. 4 is schematic structural diagram of a three-dimensional image print obtained by the three-dimensional image forming system.

Portion (a) of FIG. 5 is a schematic structural diagram of a specific example of the three-dimensional image forming system; Portion (b) of FIG. 5 is a front view thereof; and Portion (c) of FIG. 5 is a back view thereof.

Portion (a) of FIG. 6 is a schematic structural diagram of essential constituents showing another example of the three-dimensional image printer; and Portion (b) of FIG. 6 is a structural diagram of a recording sheet used in the three-dimensional image printer.

FIG. 7 is a schematic structural diagram showing another example of the three-dimensional image forming system according to the present invention.

FIG. 8 is a flow diagram showing an example for describing an operation of the three-dimensional image forming system according to the present invention.

FIG. 9 is a flow diagram showing another example for describing an operation of the three-dimensional image forming system according to the present invention.

### DETAILED DESCRIPTION OF PREFERRED EMBODIMENTS

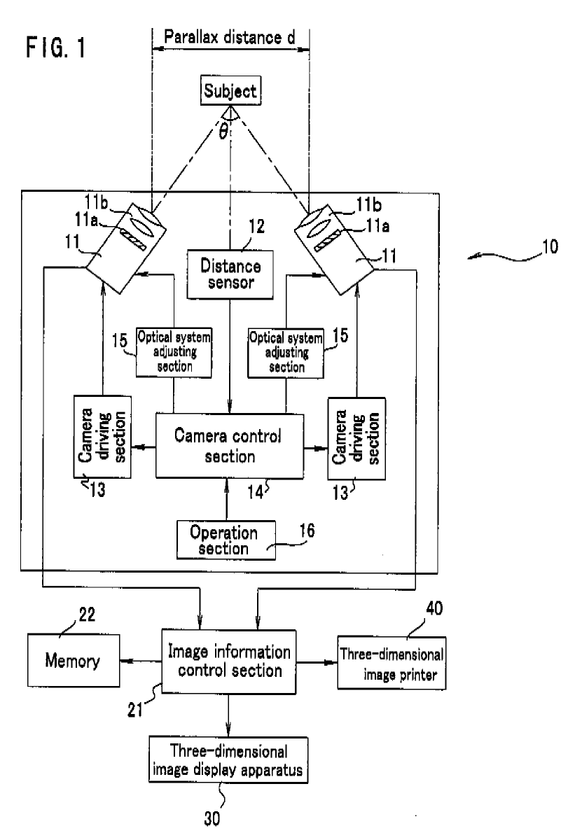

FIG. 1 is a block diagram schematically showing a structure of a three-dimensional image forming system according to the present invention. This three-dimensional image forming system includes: a three-dimensional image information obtaining apparatus 10 for obtaining three-dimensional image information of a subject; an image information control section 21 for performing a predetermined image process on the three-dimensional image information supplied thereto, which is obtained by the three-dimensional image information obtaining apparatus 10; a three-dimensional image display apparatus 30 for displaying a three-dimensional image based on the image information obtained as a result of the image-processing performed by the image information control section 21; a three-dimensional image printer 40 for printing the three-dimensional image on a recording paper, based on the image information provided from the image information control section 21; and a memory 22 as storage means for storing the image information provided from the image information control section 21.

The three-dimensional image information obtaining apparatus 10 includes: a pair of cameras 11 for obtaining image information which corresponds to an image recognized by each of the right eye and the left eye of a person; and a distance sensor 12 for measuring the relative distance between each of the cameras 11 and the subject. Each camera 11 includes: a solid-state image capturing device (CCD) 11a and an optical system 11b for focusing light onto the solid-state image capturing device 11a. The cameras 11 are disposed with constant distance d corresponding to a parallax distance there between in order to obtain the image information for the right eye and the left eye. Each camera 11 is disposed in a forward manner such that an image capturing area is located in front thereof. The optical axis of each of the optical systems 11b is disposed so as to intersect each other on a horizontal surface or on an inclined face where each optical system 11b is inclined at about 30 degrees or less in the up-and-down direction with respect to the horizontal surface. Each of the cameras 11 is rotatable on a surface, where each optical axis intersects each other, by a camera driving section 13 which is a servo motor or the like.

The distance sensor 12 is provided at a location in the middle between the cameras 11 and detects information relating to the distance to the subject which is positioned in front thereof. The information relating to the distance obtained by the distance sensor 12 is provided to a camera control section 14. The camera control section 14 computes intersecting angle θ of the optical axes of the optical systems in the cameras 11 based on distance information w to the subject provided from the distance sensor 12 and disposition distance d between the cameras 11. Based on the computed result, the camera control section 14 drives each of the camera driving sections 13 such that the optical axes intersect each other on the subject. Accordingly, each of the cameras 11 captures the subject while the optical axes intersect each other on the subject having the parallax angel θ and obtains image information for the right eye and the left eye.

In addition, optical system adjusting sections 15 are provided on the camera control section 14. Each optical system adjusting section 15 adjusts the optical system 11b provided on the camera 11 based on distance information w to the subject provided from the distance sensor 12, respectively. The optical system 11b of each of the cameras 11 is automatically adjusted by the respective optical system adjusting section 15 in order to focus on the subject.

An operation section 16 is provided in the three-dimensional image information obtaining apparatus 10, wherein an instruction for adjusting each of the optical system adjusting sections 15 is entered into the operation section 16. The camera control section 14 controls each of the optical system adjusting sections 15 based on an adjusting instruction which is entered by operating the operation section 16 by the user. For example, the camera control section 14 controls each of the optical system adjusting sections 15 based on a zooming instruction which is entered by operating the operation section 16, so that the optical system 11b of each of cameras 11 is adjusted so as to have a zoom level desired by the user.

The cameras 11 capture the subject while the focal points of the cameras 11 are matched on the subject and while the intersecting point of the optical axes are on the subject. Accordingly, each of the cameras 11 obtains the image information for each of the right eye and the left eye, respectively. The image information obtained by each of the cameras 11 is provided to the image information control section 21. The image information control section 21 performs an image process on the image information provided from the respective camera 11 for each of the right eye and the left eye so as to have a state which is suitable for displaying the three-dimensional image. Then, the image-processed image information for each of the right eye and left eye is provided to the three-dimensional image display apparatus 30, the three-dimensional image printer 40 and the memory 22, and the image information for each of the right eye and the left eye is stored in the memory 22.

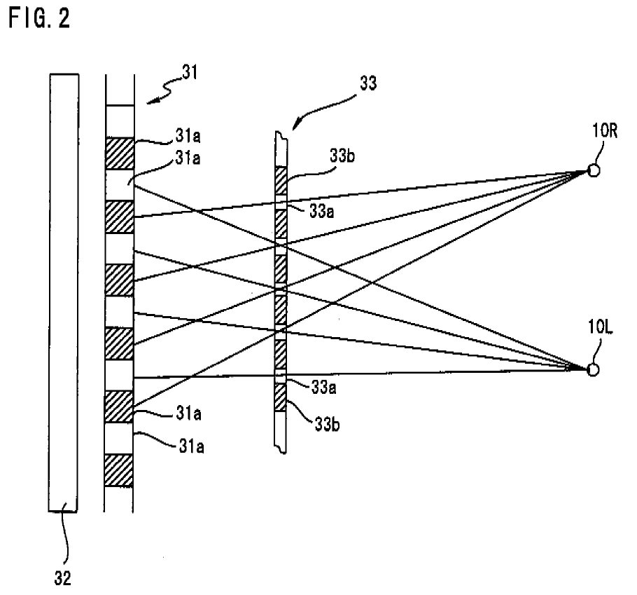

FIG. 2 is a schematic structural diagram of the three-dimensional image display apparatus 30. This three-dimensional image display apparatus 30 includes: a liquid crystal display panel 31; a backlight 32 for irradiating light onto the liquid crystal display panel 31 from the back side thereof; and a parallax barrier 33 disposed on the front (display) side of the liquid crystal display 31. The liquid crystal display panel 31 is, for example, an active matrix-type display in which each of the pixels disposed in a matrix is driven by a thin film transistor (TFT) as an active device.

The parallax barrier 33 includes: a plurality of translucent portions 33a each extending in a column direction (longitudinal direction) having a longitudinal strip shape with a small constant width so as to face the pixel columns 31a disposed along the longitudinal direction of the liquid crystal display panel 31; and a plurality of light shielding portions 33b each extending between the translucent portions 33a in the longitudinal direction having a longitudinal strip shape with a small constant width so as to shield the light from irradiating onto the border portions of the pixel columns 31a adjacent to each other in the left-and-right direction of the liquid crystal display panel 31.

In the liquid crystal display panel 31, the pixels columns 31a for the right eye, which are provided with the image information for the right eye, and the pixels columns 31a for the left eye, which are provided with the image information for the left eye, are disposed in the left-and-right (horizontal) direction in an alternating manner. Through the translucent portions 33a of the parallax barrier 33, the pixel columns 31a for the right eye are viewed by a right eye 10R of an observer, which is positioned in front of the liquid crystal display panel 31, and the pixel columns 31a for the left eye are viewed by a left eye 10L of the observer.

The image information control section 21 divides the image information obtained by the respective camera 11 for each of the right eye and the left eye into longitudinal strip shapes along a vertical (longitudinal) direction such that they correspond to the pixel columns 31a along the column (longitudinal) direction of the liquid crystal display panel 31, respectively, and the image information control section 21 processes the divided strip-shaped image information for each of the right eye and the left eye such that they are provided to the respective pixel columns along the horizontal direction of the liquid crystal display panel 31 in an alternating manner.

Each image information image-processed by the image information control section 21 is provided to the liquid crystal display panel 31. In this case, the image information for the right eye output from the image information control section 21 is provided to each of the pixel columns 31a for the right eye of the liquid crystal display panel 31, and the image information for the left eye output from the image information control section 21 is provided to each of the pixel columns 31a for the left eye of the liquid crystal display panel 31.

The light irradiated from the backlight 32 is provided to the liquid crystal display panel 31 and controlled by each of the pixels on the liquid crystal display panel 31. The light is transmissive through each of the pixels on the liquid crystal display panel 31, and also passes through each translucent portion 33a and each translucent portion 33a in the parallax barrier 33. Then, the light is irradiated onto each of the left eye and the right eye of the observer who is facing the liquid crystal display panel 31. As such, the observer recognizes the image displayed on the display panel 31 as a three-dimensional image.

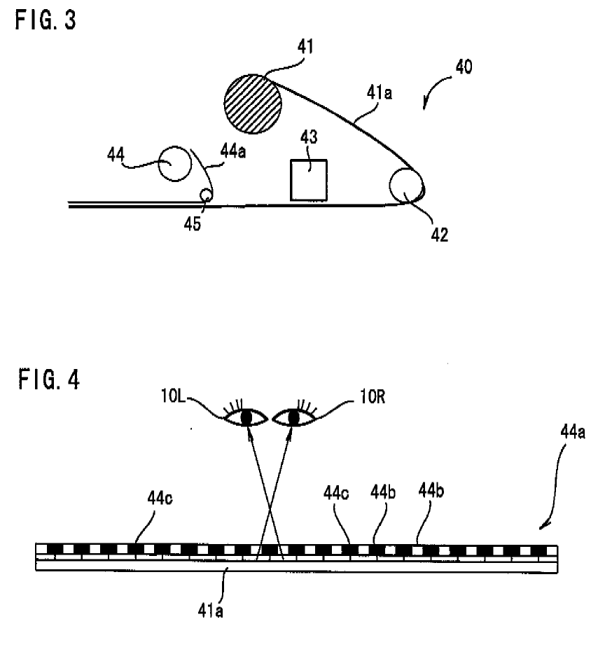

FIG. 3 is schematic structural diagram of the three-dimensional image printer 40. The three-dimensional image printer 40 has a recording sheet roll 41 mounted therein, wherein a recording sheet 41a having a three-dimensional image to be printed thereon is wound around the recording sheet roll 41 in a roll. The recording sheet 41a of the recording sheet roll 41 is pulled out by a supply roller 42. In the three-dimensional image printer 40 shown in FIG. 3, a standard paper is used as the recording sheet 41a.

A printer head 43 is provided on the three-dimensional image printer 40. The printer head 43 is disposed so as to face the recording sheet 41 supplied by the supply roller 42. The image information is provided to the printer head 43 from the image information control section 21, wherein this image information is the same as the image information for each of the right eye and the left eye that is provided from the image information control section 21 to the three-dimensional image display apparatus 30. The image, which is the same as the image displayed on the liquid crystal display panel 31 of the three-dimensional image display apparatus 30, is printed on the recording sheet 41a by the printer head 43.

A parallax barrier film roll 44 is mounted on a side of the moving direction of the recording sheet 41a, which is downstream with respect to the printer head 43, wherein a parallax barrier film 44a is wound around the parallax barrier film roll 44 in a roll. The parallax barrier film 44a pulled out by a pulling roller 45 from the parallax barrier film roll 44 is attached to an image forming surface of the recording sheet 41a having an image printed thereon by the printer head 43.

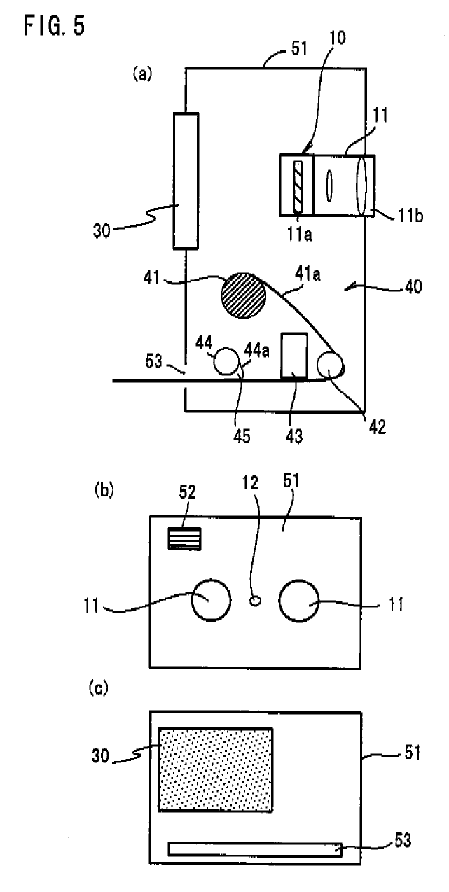

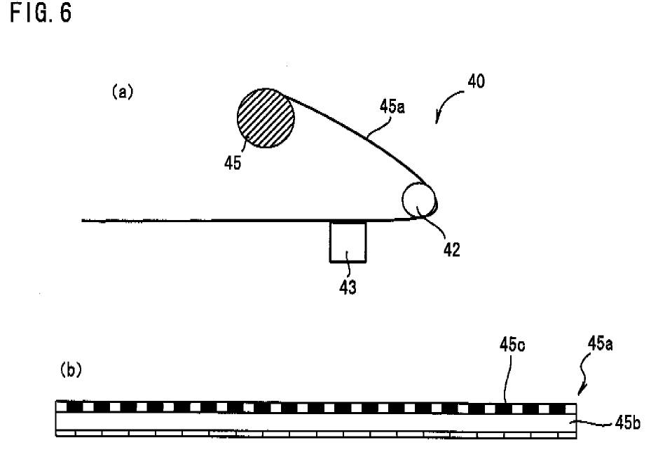

Similar to the parallax barrier 33 provided on the liquid crystal display panel 31 shown in FIG. 4, the parallax barrier film 44a includes: a plurality of striped-shaped translucent portions 44b each extending in a longitudinal direction so as to face the image information of the right eye and the left eye that is printed on the recording sheet 41a, respectively; and a plurality of strip-shaped light shielding portions 44c each provided between the adjacent translucent portions 44b and extending in the longitudinal direction so as to shield the light from irradiating onto the border portions of the image information for each of the right eye and the left eye printed on the recording sheet 41a.

The translucent portions 44b are aligned such that the parallax barrier film 44a faces the image information for each of the right eye and the left eye printed on the recording sheet 41a. Then, the parallax barrier film 44a is attached to the recording sheet 41a. When the parallax barrier film 44a is attached to the recording sheet 41a, the recording sheet 41a and the parallax barrier film 44a are cut by a cutter (not shown) such that the portion having the image information printed on the recording sheet 41a is a cut piece. As such, as shown in FIG. 4, a three-dimensional image print is formed in which the parallax barrier film 44a is attached to the recording sheet 41a having the image information for each of the right eye and the left eye printed thereon.

In the three dimensional image print formed in this manner, each image information for the right eye printed on the recording sheet 41a is viewed by the right eye 10R of the observer, and each image information for the left eye printed on the recording sheet 41a is viewed by the left eye 10L of the observer through the translucent portions 44b of the parallax barrier film 44a. As such, the observer recognizes the three-dimensional image through each image information printed on the recording sheet 41a.

Portion (a) of FIG. 5 is a schematic structural diagram of a specific example of the three-dimensional image forming system according to the present invention. Portion (b) of FIG. 5 is a front view thereof. Portion (c) of FIG. 5 is a back view thereof. The pair of automatic focusing cameras 11 is disposed in a portable casing 51, and the front end portion of each of the optical systems 11b is exposed through the front face of the casing 51. The distance sensor 12 is exposed through the center portion of the front face of the casing 51. In addition, a flash 52 is provided in a corner at the top of the front face of the casing 51.

The three-dimensional image display apparatus 30 is provided inside the back side of the casing 51. The liquid crystal display panel 31 of the three-dimensional image display apparatus 30 is disposed at an upper corner of the backside of the casing 51 such that the display surface of the liquid crystal display panel 31 is exposed through the backside of the casing 51 via the parallax barrier 33. Further, the three-dimensional image printer 40 is disposed at the bottom of the casing 51. A discharge mouth 53 is provided at a side edge portion of the lower side of the backside of the casing 51, wherein a recording paper having a three-dimensional image printed thereon by the three-dimensional image printer 40 is discharged from the discharge mouth 53. In addition, a cutter (not shown) is provided in the casing 51, for cutting the recording sheet 41a discharged from the discharge mouth 53 with a predetermined length.

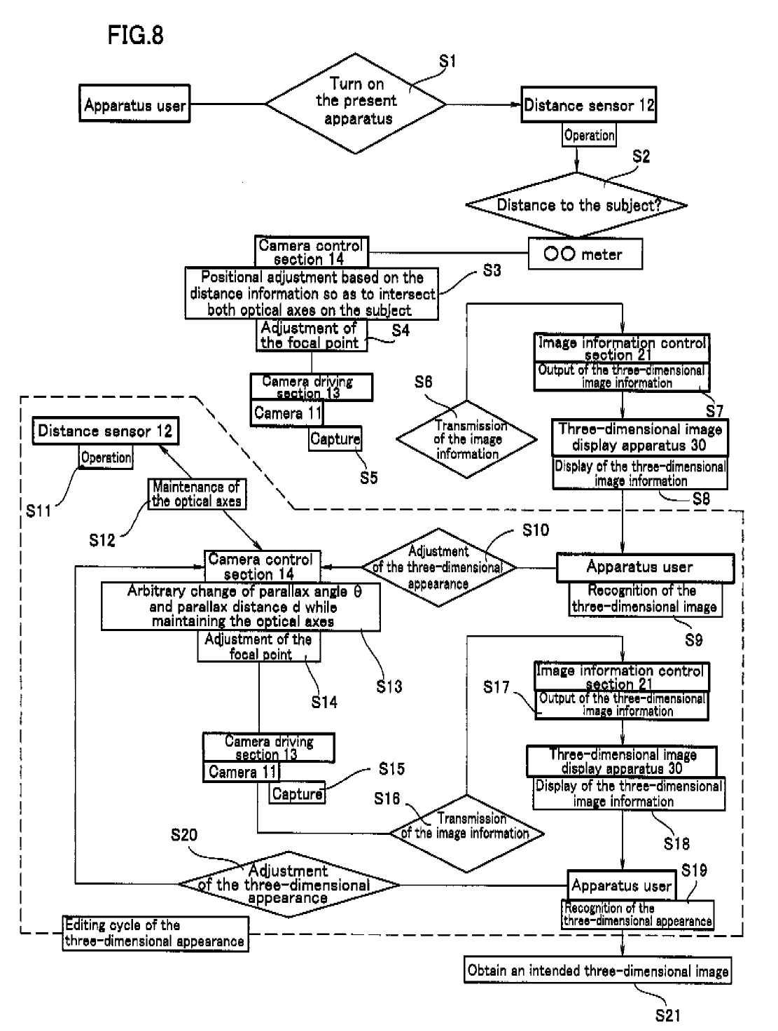

The three-dimensional image forming system having such a structure is portable. The detailed operation thereof will be described with reference to the flow diagram of FIG. 8. The flow diagram of FIG. 8 also describes main bodies for performing each operation.

When forming a three-dimensional image of a subject, first, an apparatus user turns on the present apparatus (system) (see step S1 in FIG. 8; the same applied to the rest of the steps). Accordingly, the three-dimensional image forming system becomes operable and directs the front end portion of each of the cameras 11 toward the subject. In such a state, the distance sensor 12 is operated, and the relative distance between each of the cameras 11 and the subject is detected by the distance sensor 12 (step S2). The camera control section 14 controls the camera driving sections 13 such that the optical axes of the cameras 11 intersect each other on the subject and it also controls the optical system adjusting sections 15 such that the focal points of the respective cameras are on the subject.

With the control of the optical system adjusting sections 15, the cameras 11 are adjusted to have a state where the optical axes thereof intersect each other on the subject in accordance with the condition of the parallax angle θ and the parallax distance d with respect to the subject (step S3). Moreover, the cameras 11 are adjusted to have a state where the focal points thereof are on the subject (step S4). In such a state, the camera control section 14 controls the camera driving sections 13, such that each of the cameras 11 captures the subject (step S5). As a result, the image information for each of the right eye and the left eye is obtained by the respective camera 11.

When the image information of each of the right eye and the left eye is obtained by the respective camera 11, the obtained image information is transmitted to the image information control section 21 (step S6). The image information control section 21, as described above, processes each transmitted image information and outputs it to the three-dimensional image display apparatus 30 (step S7). As a result, a three-dimensional image is displayed on the liquid crystal display panel 31 of the three-dimensional image display apparatus 30 (step S8).

When the image is displayed on the liquid crystal panel 31 of the three-dimensional image display apparatus 30 in this manner, an editing cycle is performed in order to adjust a three-dimensional appearance of the displayed three-dimensional image. When the three-dimensional image displayed on the liquid crystal display panel 31 is observed by the apparatus user through the parallax barrier 33, which is provided on the display panel 31, the apparatus user recognizes the image displayed on the liquid crystal display panel 31 as a three-dimensional image (step S9) and compares this recognized three-dimensional image with the actual viewed image of the subject or the like so as to adjust the three-dimensional appearance of the displayed three-dimensional image by operating the operation section 16 or the like (step S10). With the operation of the operation section 16, the camera control section 14 operates the distance sensor 12 (step S11), stores the optical axes of the cameras 11 (step S12) and adjusts the cameras 11 while storing the optical axes of the cameras 11 such that the parallax angle θ, the parallax distance d and the zoom level are changed (step S13). Concurrently, the focus level of the each of the cameras 11 is adjusted (step S14).

When the cameras 11 are adjusted in this manner, the camera driving sections 13 are controlled and the subject is captured by the cameras 11 (step S15). Hereinafter, similar to the operations described above, when the image information of each of the right eye and the left eye is obtained by the respective camera 11, the obtained image information is transmitted to the image information control section 21 (step S16) The image information control section 21, as described above, processes each transmitted image information and outputs it to the three-dimensional image display apparatus 30 (step S17) As a result, a three-dimensional image is displayed on the liquid crystal display panel 31 of the three-dimensional image display apparatus 30 (step S18). The displayed three-dimensional image is recognized by the apparatus user (step S19).

When it is necessary to further adjust the three-dimensional appearance of the three-dimensional image displayed on the liquid crystal display panel 31 of the three-dimensional image display apparatus 30, the adjustment is performed by operating the operation section 16 or the like (step S20). Hereinafter, by repeating steps S11 through S19, the adjustment (editing) of the three-dimensional appearance is performed.

As described above, the user compares the three-dimensional image displayed on the liquid crystal display panel 31 and the actual stereoscopic image of the subject recognized by the user's eyes. When the three-dimensional image displayed on the liquid crystal display panel 31 matches the image desired by the user, then the user operates a switch of the operation section 16 provided on the casing 51 to instruct a printing operation by the three-dimensional image printer 40. As a result, the three-dimensional image printer 40 is operated, and the image information for each of the right eye and the left eye is printed on the recording sheet 41a. Also, the parallax barrier film 44a is attached to the recording sheet 41a so as to cover each printed image information. Then, the recording sheet 41a and the parallax barrier film 44a are cut, so that the three-dimensional image print is discharged outside the casing 51.

The three-dimensional image print obtained in this manner is the three-dimensional image confirmed by the user by way of the liquid crystal display panel 31. Thus, the user can obtain the three-dimensional image print having the desired three-dimensional image formed thereon (step S21).

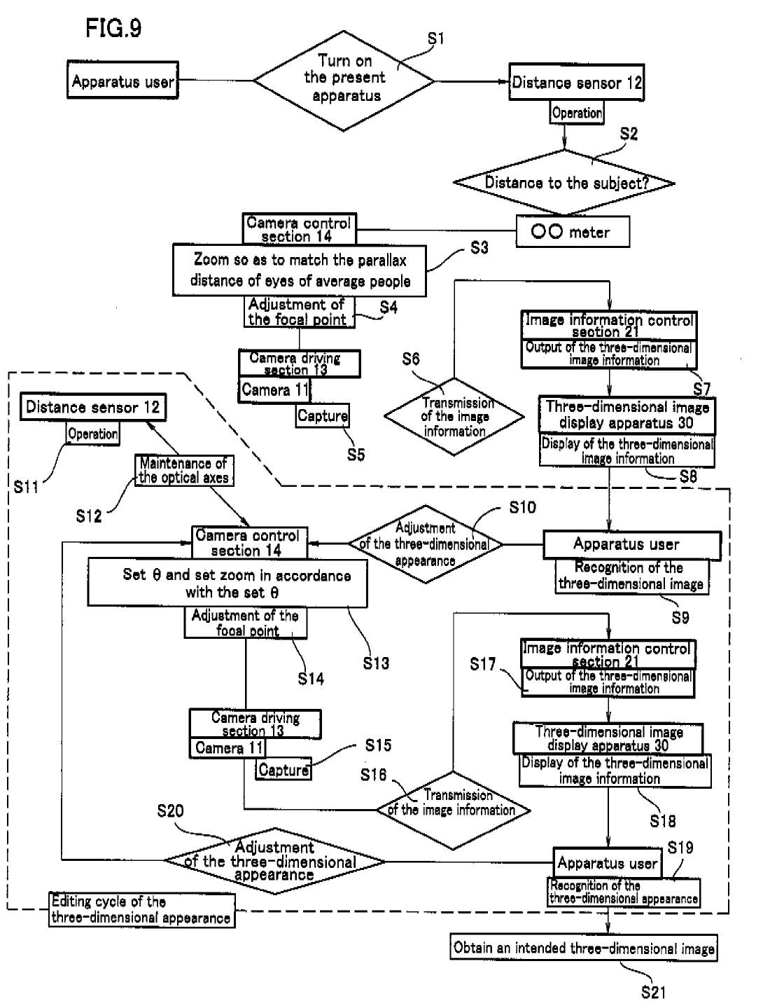

In the above description, step S3 has a structure of adjusting the cameras 11 based on the distance information obtained by the distance sensor 12 in order to have a state where the optical axes of the cameras 11 intersect each other on the subject in accordance with the condition of the parallax angle θ and the parallax distance d with respect to the subject. However, as shown in step S3 of FIG. 9, with the parallax distance d being set as a parallax distance of average people's eyes, the parallax angel can be set based on the distance to the subject. In other words, in the case of the average people's eyes, the parallax distance d is constant, and the parallax angle θ is uniquely decided based on the distance to the subject and the focal adjustment is performed. Therefore, only by setting the parallax angle θ based on the distance to the subject, an automatic adjustment is performed so as to have a state, which is closer to the three-dimensional appearance recognized by a person's eyes. In this case, also in step S13 of adjusting the three-dimensional appearance, the parallax angle θ is set based on the distance to the subject and the zoom level is adjusted based on the set parallax angle θ.

Portion (a) of FIG. 6 is a schematic structural diagram showing another example of the three-dimensional image printer 40. Portion (b) of FIG. 6 is a structural diagram of a recording sheet 45a used in the three-dimensional image printer 40. The recording sheet 45a used in the three-dimensional image printer 40 has a structure having a parallax barrier film 45c attached to one side of a transparent sheet 45b. The parallax barrier film 45c has a similar structure to that of the parallax barrier film 44a used in the three-dimensional image printer 40 described above.

A recording sheet roll 45 is mounted in the three-dimensional image printer 40, wherein the recording sheet 45a is wound around the recoding sheet roll 45 in a roll. A printer head 43 is disposed so as to face the side of the transparent sheet 45b, to which the parallax barrier film 45c is not attached, in the recording sheet 45a pulled out from the recording sheet roll 45. The printer head 43 prints image information for each of the right eye and the left eye on the side of the transparent sheet 45b, to which the parallax barrier film 45c is not attached.

The rest of the structure is similar to that of the three-dimensional image printer 40 described above.

The three-dimensional image printer 40 having such a structure can print a desired three-dimensional image easily and reliably.

The three-dimensional image printer 40 in the embodiments described above has a structure where the light shielding portions and the translucent portions of the parallax barrier film 41b or 45c used in the recording sheet 41a or 45a are formed in an alternating manner. However, a parallax barrier film having a structure where the lenticular lenses having strip shapes extending in a longitudinal direction are formed side by side in a continuous manner in the left-and-right direction can also be used.

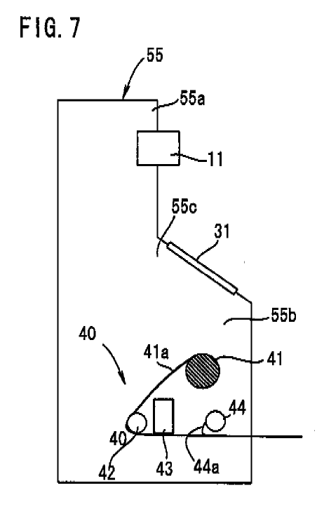

FIG. 7 is a schematic structural diagram showing another example of the three-dimensional image forming system according to the present invention. In this three-dimensional image forming system, the image information obtaining apparatus 10, the image information control section 21, the three-dimensional image display apparatus 30, the three-dimensional image printer 40 and the memory 52 are provided in a fixed-type casing 55.

The casing 55 includes: an upper portion 55a where the three-dimensional image information obtaining apparatus 10 is disposed; a lower portion 55b where the three-dimensional image printer 40 is disposed; and a middle portion 55c where the three-dimensional image display apparatus 30 is disposed. The lower portion 55b has a shape such that it is projected forward with respect to the upper portion 55a. The front face of the middle portion 55c is an inclined face such that the front face is sequentially located forward toward the lower side of the middle portion 55c. The area captured by the pair of cameras 11 is located in front of the three-dimensional image information obtaining apparatus 10, which is disposed at the upper portion 55a, and the front end portion of each of the cameras 11 is exposed through the front face of the upper portion 55a. The distance sensor 12 is also exposed through the front face of the upper portion 55a. In the inclined face of the middle portion 55c, the display surface of the liquid crystal display panel 31 of the three-dimensional image display apparatus 30 is disposed along the inclined face of the middle portion 55c. A touch panel (not shown) is provided on the display surface of the liquid crystal display panel 31, and it is possible to instruct the start of the operation of the three-dimensional image printer 40, the zooming level of the cameras 11 and the like by operating the touch panel.

Since the display surface of the liquid crystal display panel 31 is provided on the inclined face of the middle portion 55c, the observer of the liquid crystal display panel 31 is positioned in front of the casing 55. Therefore, the observer can be captured by the pair of the cameras 11 provided at the upper portion 55a.

In the fixed-type three dimensional image forming system having such a structure, it is possible to capture the user him-self/herself as a subject by the cameras 11, and it is also possible by the three-dimensional image printer 40 to obtain a three-dimensional image print of the user himself/herself based on the image information obtained by each of the cameras 11.

In this case, a touch panel can be provided on the display surface of the liquid crystal display panel 31. With the provision of the touch panel on the display surface of the liquid crystal display panel 31, the observer of the liquid crystal display panel 31 can easily adjust the optical axes and the like of the cameras 11 of the three-dimensional image information obtaining apparatus 10 by operating the touch panel. The touch panel is not limited to the one having a system of pressing a finger or the like on the display surface of the liquid crystal display panel 31, but it can have a pen method of contacting a pen thereon so as to enter information.

The embodiments described above have a structure that the image information obtained by the image information control section 21 is stored in the memory 22, so that by using the image information stored in the memory 22 a plurality of times, it is possible to obtain a plurality of three-dimensional image prints by the three-dimensional image printer 40. In addition, the image information stored in the memory 22 can be provided to a three-dimensional image printer other than the three-dimensional image printer 40 provided in the three-dimensional image forming system according to the present invention in order to obtain a three-dimensional image print. In this case, the memory 22 is detachable from the casing, and thus it is possible to easily provide the image information stored in the memory 22 to another three-dimensional image printer.

Further, an adhesive layer can be provided in advance on the back side of a recording sheet, which is provided in the three-dimensional image printer 40, and a release paper can be provided on the adhesive layer. As such, when the release paper is released, the three-dimensional image print obtained by the three-dimensional image printer 40 can be attached to a desired member (e.g., notebook) for storage with the adhesive layer when the release paper is released.

As described above, the present invention is exemplified by the use of its preferred embodiment(s). However, the present invention should not be interpreted solely based on the present embodiment(s). It is understood that the scope of the present invention should be interpreted solely based on the claims. It is also understood that those skilled in the art can implement equivalent scope of technology, based on the description of the present invention and common knowledge from the description of the detailed preferred embodiment(s) of the present invention. Furthermore, it is understood that any patent, any patent application and any references cited in the present specification should be incorporated by reference in the present specification in the same manner as the contents are specifically described therein.

In three-dimensional image forming system for forming a three-dimensional image in line with a stereoscopic image recognized by a person's eyes, it is possible to improve the economic efficiency.

1. A three-dimensional image forming system, comprising:
a three-dimensional image information obtaining apparatus for obtaining image information for each of a right eye and a left eye;
an image information control section for image-processing the image information for each of the right eye and the left eye obtained by the three-dimensional image information obtaining apparatus; and
a three-dimensional image display apparatus including a display section for displaying the image information for each of the right eye and the left eye obtained by the image information control section such that each image information is observed by the right eye and the left eye of an observer, respectively.

2. A three-dimensional image forming system according to claim 1, wherein the three-dimensional image information obtaining apparatus includes means for changing a parallax angle, the parallax angle occurring when the image information for each of the right eye and the left eye is obtained.

3. A three-dimensional image forming system according to claim 2, wherein the three-dimensional image information obtaining apparatus includes a pair of cameras disposed with a predetermined interval there between in order to obtain the image information for each of the right eye and the left eye, and an optical axis of each of optical systems of the respective cameras is disposed so as to intersect each other on a horizontal surface or on an inclined face inclined with respect to the horizontal surface.

4. A three-dimensional image forming system according to claim 3, wherein the three-dimensional image information obtaining apparatus includes a distance sensor for detecting a distance between each of the cameras and a subject, and an optical axis direction of each of the cameras is adjusted based on a detection result of the distance sensor such that an intersecting point of the optical axes of the cameras is on the subject.

5. A three-dimensional image forming system according to claim 4, wherein a focal position of each camera of the three-dimensional image information obtaining apparatus is automatically adjusted based on the distance sensor.

6. A three-dimensional image forming system according to claim 1, wherein the image information control section image-processes and outputs the image information for each of the right eye and the left eye obtained by the image information obtaining apparatus such that each image information is displayed by the display section of the three-dimensional image display apparatus in an alternating manner in a left-and-right direction.

7. A three-dimensional image forming system according to claim 6, wherein the display section of the three-dimensional image display apparatus includes a display panel; and a parallax barrier disposed along the display panel such that the image information for each of the right eye and the left eye displayed on the display panel is observed by the right eye and the left eye of the observer, respectively.

8. A three-dimensional image forming system according to claim 1, further comprising a three-dimensional image printer for forming a three-dimensional image print based on an output from the image information control section.

9. A three-dimensional image forming system according to claim 8, wherein the three-dimensional image information obtaining apparatus, the three-dimensional image display apparatus, the image information control section and the three-dimensional image printer are held in a portable casing.

10. A three-dimensional image forming system according to claim 8, wherein the three-dimensional image information obtaining apparatus, the three-dimensional image display apparatus, the image information control section and the three-dimensional image printer are held in a fixed-type casing, and each camera of the image information obtaining apparatus is disposed such that the observer of the three-dimensional image display apparatus becomes the subject.

11. A three-dimensional image forming system according to claim 10, wherein the three-dimensional image display apparatus includes a touch panel on a display surface thereof, and the three-dimensional image information apparatus can be operated by an operation of the touch panel.

12. A three-dimensional image forming system according to claim 11, wherein the touch panel employs a pen input method.

13. A three-dimensional image forming system according to claim 8, further comprising storage means for storing the image information for each of the right eye and the left eye obtained by the image information control section.

14. A three-dimensional image forming system according to claim 13, wherein the storage means is detachable from the casing.

15. A three-dimensional image forming system according to claim 8, wherein the three-dimensional image printer includes a printer head for printing the image information output from the image information control section for each of the right eye and the left eye on a recording sheet in an alternating manner in a left-and-right direction.

16. A three-dimensional image forming system according to claim 15, wherein the three-dimensional image printer further includes means for attaching a parallax barrier film on the recording sheet having the image information of each of the right eye and the left eye printed thereon by the printer head in the alternating manner, light transmissive areas respectively corresponding to each printed image information being provided in the parallax barrier film, such that each light transmissive area corresponds to each image information printed on the recording sheet, respectively.

17. A three-dimensional image forming system according to claim 15, wherein the recording sheet of the three-dimensional image printer includes a translucent sheet; and a parallax barrier sheet on one side of the translucent sheet, a plurality of light transmissive areas being provided in the parallax barrier sheet side by side in the left-and-right direction, and the printer head prints the image information for each of the right eye and the left eye on a side, on which the parallax barrier film of the translucent sheet in the recording sheet is not provided, in the alternating manner in the left-and-right direction so as to correspond to each of the light transmissive areas.

18. A three-dimensional image forming system according to claim 16, wherein the parallax barrier film of the three-dimensional image printer includes a plurality of translucent portions facing each of print positions of the image information for each of the right eye and the left eye in the recording sheet; and a plurality of light shielding portions for shielding light irradiating between each of the translucent portions.

19. A three-dimensional image forming system according to claim 16, wherein the recording sheet includes an adhesive layer on a back side thereof.

20. A three-dimensional image forming system according to claim 19, wherein a release paper is provided on a surface of the adhesive layer.

21. A three-dimensional image forming system according to claim 1, wherein the three-dimensional image display apparatus is a liquid crystal display apparatus.
